(19) United States
(12) Patent Application Publication
(10) Pub. No.: US 2013/0167090 A1
(43) Pub. Date: Jun. 27, 2013

(54) DEVICE, METHOD, AND STORAGE MEDIUM STORING PROGRAM

(71) Applicant: Kyocera Corporation, Kyoto-shi (JP)

(72) Inventor: Makoto TOMIZU, Yokohama-shi (JP)

(73) Assignee: KYOCERA CORPORATION, Kyoto-shi (JP)

(21) Appl. No.: 13/723,376

(22) Filed: Dec. 21, 2012

(30) Foreign Application Priority Data
Dec. 22, 2011 (JP) 2011-282344
Dec. 20, 2012 (JP) 2012-278180

(51) Int. Cl. G06F 3/0482

(52) U.S. Cl. CPC G06F 3/0482
USPC 715/835

(57) ABSTRACT

According to an aspect, a device includes a touch screen display and a controller. The touch screen display displays a first folder storing a first icon and a second folder storing a second icon. The controller combines the first folder and the second folder in accordance with a predetermined gesture made on the touch screen display.

### CROSS-REFERENCE TO RELATED APPLICATIONS

This application claims priority from Japanese Application No. 2011-282344, filed on Dec. 22, 2011, and Japanese Application No. 2012-278180, filed on Dec. 20, 2012, the contents of which are incorporated by reference herein in their entireties.

### BACKGROUND

1. Technical Field

The present application relates to a device, a method, and a storage medium storing therein a program. More particularly, the present application relates to a device including a touch screen, a method of controlling the device, and a storage medium storing therein a program for controlling the device.

2. Description of the Related Art

A touch screen device having a touch screen has been known. Examples of the touch screen devices include, but are not limited to, a smartphone and a tablet. The touch screen device detects a gesture of a finger, a pen, or a stylus pen through the touch screen. Then, the touch screen device operates according to the detected gesture. An example of the operation according to the detected gesture is described in, for example, International Publication Pamphlet No. 2008/086302.

The basic operation of the touch screen device is implemented by an operating system (OS) built into the device. Examples of the OS built into the touch screen device include, but are not limited to, Android, BlackBerry OS, iOS, Symbian OS, and Windows Phone.

Most of touch screen devices display a screen called a home screen. In the home screen, objects called icons are arranged. When detecting a gesture for an icon, the touch screen device executes an application corresponding to the icon for which the gesture is performed.

The more applications are installed to the touch screen device, the more icons are arranged in the home screen. In order to organize the icons, folders for storing icons may be arranged in the home screen. The folder plays an important role of organizing the home screen in an easy-to-use manner while allowing a user to use various applications. For the foregoing reasons, there is a need for a device, a method, and a program capable of improving the operability of the folders.

### SUMMARY

According to an aspect, a device includes a touch screen display and a controller. The touch screen display displays a first folder storing a first icon and a second folder storing a second icon. The controller combines the first folder and the second folder in accordance with a predetermined gesture made on the touch screen display.

According to another aspect, a method is for controlling a device having a touch screen display. The method includes: displaying a first folder storing a first icon and a second folder storing a second icon on the touch screen display; detecting, with the touch screen display, a predetermined gesture; and combining the first folder and the second folder in accordance with the predetermined gesture.

According to another aspect, a non-transitory storage medium stores a program. When executed by a device having a touch screen display, the program causes the device to execute: displaying a first folder storing a first icon and a second folder storing a second icon on the touch screen display; detecting, with the touch screen display, a predetermined gesture; and combining the first folder and the second folder in accordance with the predetermined gesture.

### BRIEF DESCRIPTION OF THE DRAWINGS

FIG. 1 is a perspective view of a smartphone according to an embodiment;

FIG. 2 is an elevation view of the smartphone;

FIG. 3 is a rear view of the smartphone;

FIG. 4 is a diagram illustrating an example of a home screen;

FIG. 5 is a block diagram of the smartphone;

FIG. 6 is a diagram illustrating an example of combining of folders;

FIG. 7 is a flowchart illustrating a processing procedure of combining processing of folders;

FIG. 8 is a diagram illustrating an example of operation for dragging multiple folders and bringing them closer to each other;

FIG. 9 is a diagram illustrating an example of operation for dragging one folder and bringing the folder closer to another folder;

FIG. 10 is a diagram illustrating another example of operation for dragging a folder and bringing the folder closer to another folder;

FIG. 11 is a diagram illustrating an example of operation for flicking a folder in a direction of another folder;

FIG. 12 is a diagram illustrating an example of another multi-touch gesture; and

FIG. 13 is a diagram illustrating another example of operation for combining folders.

### DETAILED DESCRIPTION

Exemplary embodiments of the present invention will be explained in detail below with reference to the accompanying drawings. A smartphone will be explained below as an example of a device including a touch screen.

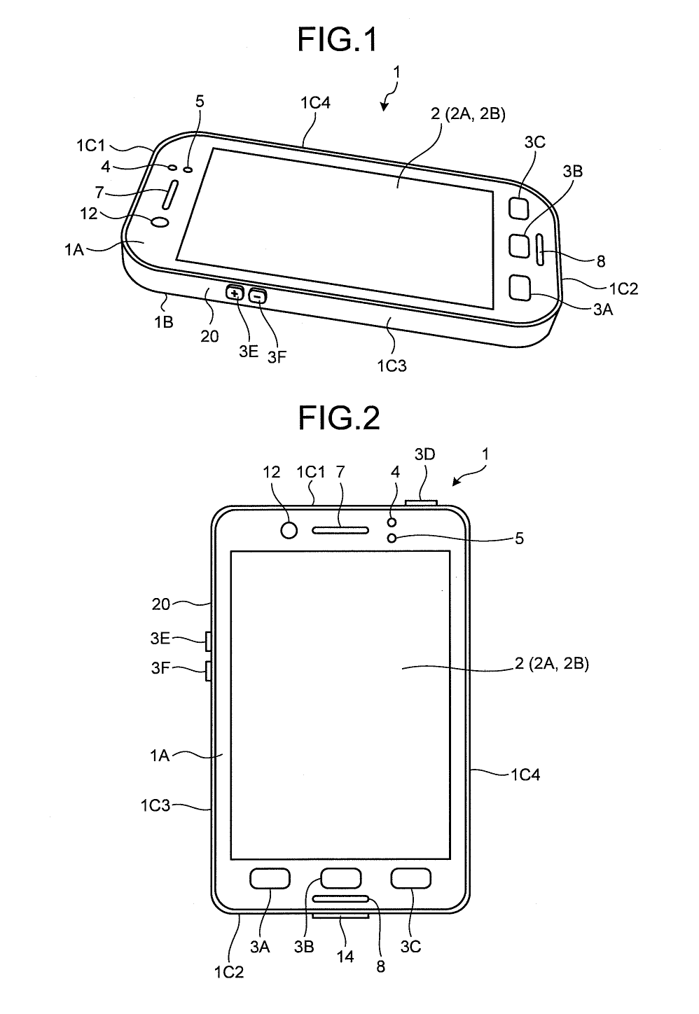

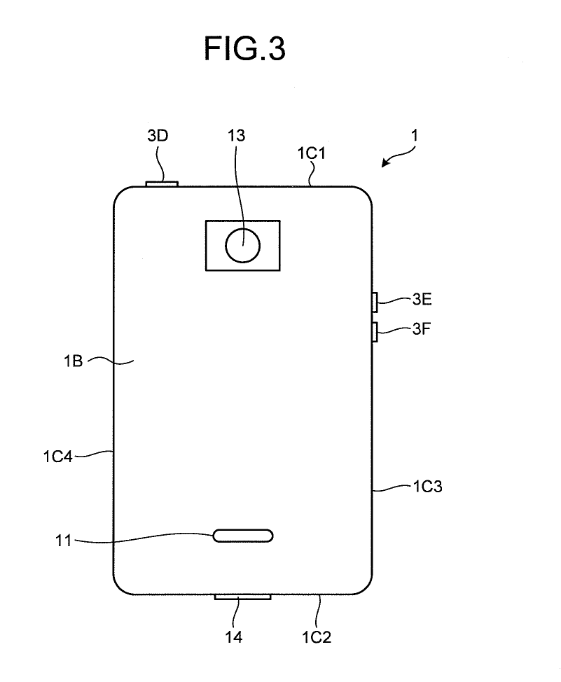

An overall configuration of a smartphone 1 according to an embodiment will be explained below with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 includes a touch screen display 2, buttons 3A to 3C, an illumination (ambient light) sensor 4, a proximity sensor 5, a receiver 7, a microphone 8, and a camera 12, which are provided in the front face 1A. The smartphone 1 includes a speaker 11 and a camera 13, which are provided in the back face 1B. The smartphone 1 includes buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, each of the display 2A and the touch screen 2B is approximately rectangular-shaped; however, the shapes of the display 2A and the touch screen 2B are not limited thereto. Each of the display 2A and the touch screen 2B may have any shape such as a square, a circle or the like. In the example of FIG. 1, the display 2A and the touch screen 2B are arranged in a superimposed manner; however, the manner in which the display 2A and the touch screen 2B are arranged is not limited thereto. The display 2A and the touch screen 2B may be arranged, for example, side by side or apart from each other. In the example of FIG. 1, longer sides of the display 2A are along with longer sides of the touch screen 2B respectively while shorter sides of the display 2A are along with shorter sides of the touch screen 2B respectively; however, the manner in which the display 2A and the touch screen 2B are superimposed is not limited thereto. In case the display 2A and the touch screen 2B are arranged in the superimposed manner, they can be arranged such that, for example, one or more sides of the display 2A are not along with any sides of the touch screen 2B.

The display 2A is provided with a display device such as a liquid crystal display (LCD), an organic electro-luminescence display (GELD), or an inorganic electro-luminescence display (IELD). The display 2A displays text, images, symbols, graphics, and the like.

The touch screen 2B detects a contact of a finger, pen, a stylus pen, or the like on the touch screen 2B. The touch screen 2B can detect positions where a plurality of fingers, pens, stylus pens, or the like make contact with the touch screen 2B. In the description herein below, a finger, pen, stylus pen, and the like may be referred to as a “contact object” or an “object”.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the smartphone 1.

The smartphone 1 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the smartphone 1 include, but are not limited to, touch, long touch, release, swipe, tap, double tap, long tap, drag, flick, pinch in, and pinch out.

“Touch” is a gesture in which a finger makes contact with the touch screen 2B. The smartphone 1 determines a gesture in which the finger makes contact with the touch screen 2B as touch. “Long touch” is a gesture in which a finger makes contact with the touch screen 2B for longer than a given time. The smartphone 1 determines a gesture in which the finger makes contact with the touch screen 2B for longer than a given time as long touch.

“Release” is a gesture in which a finger separates from the touch screen 2B. The smartphone 1 determines a gesture in which the finger separates from the touch screen 2B as release. “Swipe” is a gesture in which a finger moves on the touch screen 2B with continuous contact thereon. The smartphone 1 determines a gesture in which the finger moves on the touch screen 2B with continuous contact thereon as swipe.

“Tap” is a gesture in which a touch is followed by a release. The smartphone 1 determines a gesture in which a touch is followed by a release as tap. “Double tap” is a gesture such that a gesture in which a touch is followed by a release is successively performed twice. The smartphone 1 determines a gesture such that a gesture in which a touch is followed by a release is successively performed twice as double tap.

“Long tap” is a gesture in which a long touch is followed by a release. The smartphone 1 determines a gesture in which a long touch is followed by a release as long tap. “Drag” is a gesture in which a swipe is performed from an area where a movable-object is displayed. The smartphone 1 determines a gesture in which a swipe is performed from an area where the movable-object displayed as drag.

“Flick” is a gesture in which a finger separates from the touch screen 2B while moving after making contact with the touch screen 2B. That is, “Flick” is a gesture in which a touch is followed by a release accompanied with a movement of the finger. The smartphone 1 determines a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch in” is a gesture in which a swipe with a plurality of fingers is performed in a direction to move the fingers toward each other. The smartphone 1 determines a gesture in which the distance between a position of one finger and a position of another finger detected by the touch screen 2B becomes shorter as pinch in. “Pinch out” is a gesture in which a swipe with a plurality of fingers is performed in a direction to move the fingers away from each other. The smartphone 1 determines a gesture in which the distance between a position of one finger and a position of another finger detected by the touch screen 2B becomes longer as pinch out.

In the description herein below, a gesture performed by using a finger may be referred to as a “single touch gesture”, and a gesture performed by using a plurality of fingers may be referred to as a “multi touch gesture”. Examples of the multi touch gesture include a pinch in and a pinch out. A tap, a flick, a swipe, and the like are a single touch gesture when performed by using a finger, and are a multi touch gesture when performed by using a plurality of fingers.

The smartphone 1 performs operations according to these gestures which are determined through the touch screen 2B. Therefore, user-friendly and intuitive operability is achieved. The operations performed by the smartphone 1 according to the determined gestures may be different depending on the screen displayed on the display 2A. In the following explanation, for the sake of simplicity of explanation, the fact that the touch screen detects the contact(s) and then the smartphone determines the type of the gesture as X based on the contact(s) may be simply described as “the smartphone detects X” or “the controller detects X”.

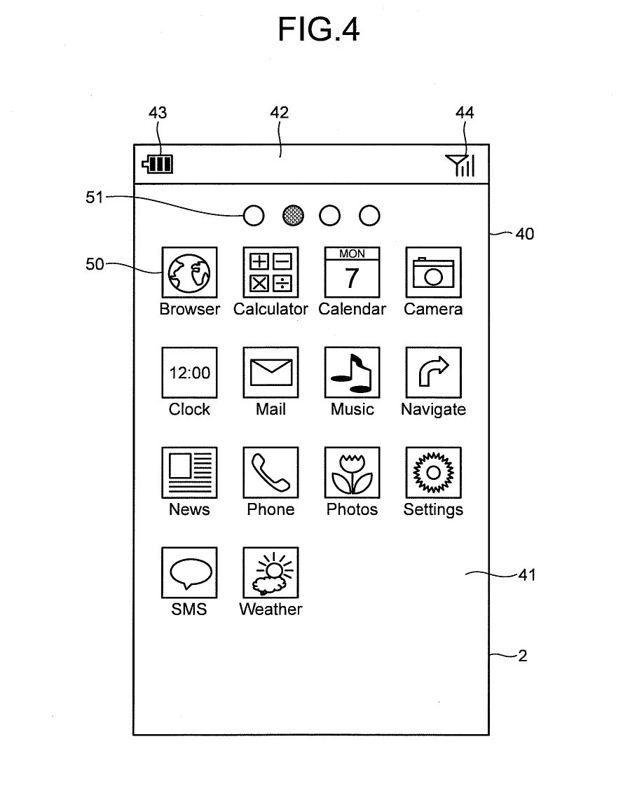

An example of the screen displayed on the display 2A will be explained below with reference to FIG. 4. FIG. 4 represents an example of a home screen. The home screen may also be called “desktop”, “standby screen”, “idle screen”, or “standard screen”. The home screen is displayed on the display 2A. The home screen is a screen allowing the user to select which one of applications (programs) installed in the smartphone 1 is executed. The smartphone 1 executes the application selected on the home screen in the foreground. The screen of the application executed in the foreground is displayed on the display 2A.

Icons can be arranged on the home screen of the smartphone 1. A plurality of icons 50 are arranged on a home screen 40 illustrated in FIG. 4. Each of the icons 50 is previously associated with an application installed in the smartphone 1. When detecting a gesture for an icon 50, the smartphone 1 executes the application associated with the icon 50 for which the gesture is detected. For example, when detecting a tap on an icon 50 associated with a mail application, the smartphone 1 executes the mail application.

The icons 50 include an image and a character string. The icons 50 may contain a symbol or a graphic instead of an image. The icons 50 do not have to include either one of the image and the character string. The icons 50 are arranged based on a layout pattern. A wall paper 41 is displayed behind the icons 50. The wall paper may sometimes be called “photo screen”, “back screen”, “idle image”, or “background image”. The smartphone 1 can use an arbitrary image as the wall paper 41. The smartphone 1 may be configured so that the user can select an image to be displayed as the wall paper 41.

The smartphone 1 can include a plurality of home screens. The smartphone 1 determines, for example, the number of home screens according to setting by the user. The smartphone 1 displays a selected one on the display 2A even when there is a plurality of home screens.

The smartphone 1 displays an indicator (a locator) 51 on the home screen. The indicator 51 includes one or more symbols. The number of the symbols is the same as that of the home screens. In the indicator 51, a symbol corresponding to a home screen that is currently displayed is displayed in a different manner from that of symbols corresponding to the other home screens.

The indicator 51 in an example illustrated in FIG. 4 includes four symbols. This means the number of home screens is four. According to the indicator 51 in the example illustrated in FIG. 4, the second symbol from the left is displayed in a different manner from that of the other symbols. This means that the second home screen from the left is currently displayed.

The smartphone 1 can change a home screen to be displayed on the display 2A. When a gesture is detected while displaying one of home screens, the smartphone 1 changes the home screen to be displayed on the display 2A to another one. For example, when detecting a rightward flick, the smartphone 1 changes the home screen to be displayed on the display 2A to a home screen on the left side. For example, when detecting a leftward flick, the smartphone 1 changes the home screen to be displayed on the display 2A to a home screen on the right side. The smartphone 1 changes the home screen to be displayed on the display 2A from a first home screen to a second home screen, when a gesture is detected while displaying the first home screen, such that the area of the first home screen displayed on the display 2A gradually becomes smaller and the area of the second home screen displayed gradually becomes larger. The smartphone 1 may switch the home screens such that the first home screen is instantly replaced by the second home screen.

An area 42 is provided along the top edge of the display 2A. Displayed on the area 42 are a remaining mark 43 indicating a remaining amount of a power supply and a radio-wave level mark 44 indicating an electric field strength of radio wave for communication. The smartphone 1 may display time, weather, an application during execution thereof, a type of communication system, a status of a phone call, a mode of the device, an event occurring in the device, and the like in the area 42. In this manner, the area 42 is used to inform the user of various notifications. The area 42 may be provided on any screen other than the home screen 40. A position where the area 42 is provided is not limited to the top edge of the display 2A.

The home screen 40 illustrated in FIG. 4 is only an example, and therefore the configuration of each of elements, the arrangement of the elements, the number of home screens 40, the way to perform each of operations on the home screen 40, and the like do not have to be like the above mentioned explanation.

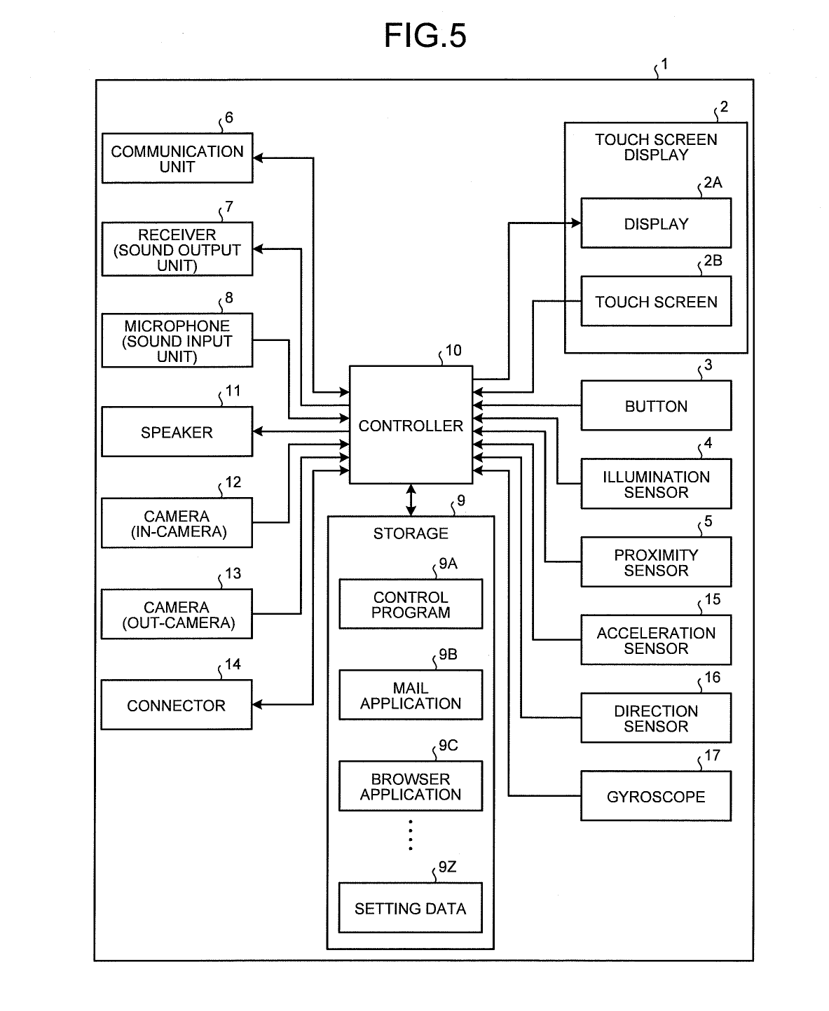

FIG. 5 is a block diagram of the smartphone 1. The smartphone 1 includes the touch screen display 2, the button 3, the illumination sensor 4, the proximity sensor 5, a communication unit 6, the receiver 7, the microphone 8, a storage 9, a controller 10, the speaker 11, the cameras 12 and 13, the connector 14, an acceleration sensor 15, a direction (orientation) sensor 16, and a gyroscope 17.

The touch screen display 2 includes, as explained above, the display 2A and the touch screen 2B. The display 2A displays text, images, symbols, graphics, or the like. The touch screen 2B detects contact(s). The controller 10 detects a gesture performed for the smartphone 1. Specifically, the controller 10 detects an operation (a gesture) for the touch screen 2B in cooperation with the touch screen 2B.

The button 3 is operated by the user. The button 3 includes buttons 3A to 3F. The controller 10 detects an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

The illumination sensor 4 detects illumination of the ambient light of the smartphone 1. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field, a change of the return time of the reflected ultrasonic wave, etc. The proximity sensor 5 detects that, for example, the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards.

The receiver 7 and the speaker 11 are sound output units. The receiver 7 and the speaker 11 output a sound signal transmitted from the controller 10 as sound. The receiver 7 is used, for example, to output voice of the other party on the phone. The speaker 11 is used, for example, to output a ring tone and music. Either one of the receiver 7 and the speaker 11 may double as the other function. The microphone 8 is a sound input unit. The microphone 8 converts speech of the user or the like to a sound signal and transmit the converted signal to the controller 10.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

Programs stored in the storage 9 include applications executed in the foreground or the background and a control program for assisting operations of the applications. The application causes the controller 10, for example, to display a screen on the display 2A and perform a process according to a gesture detected through the touch screen 2B. The control program is, for example, an OS. The applications and the control program may be installed in the storage 9 through communication by the communication unit 6 or through a non-transitory storage medium.

For example, the storage 9 stores a control program 9A, a mail application 9B, a browser application 9C, and setting data 9Z. The mail application 9B provides an e-mail function. The e-mail function enables, for example, composition, transmission, reception and display of an e-mail. The browser application 9C provides a WEB browsing function. The WEB browsing function enables, for example, display of a WEB page and editing of a bookmark. The setting data 9Z include information about various kinds of settings about operation of the smartphone 1.

The control program 9A provides a function related to various controls for operating the smartphone 1. The control program 9A controls, for example, the communication unit 6, the receiver 7, and the microphone 8 to make a phone call. The function provided by the control program 9A includes functions for performing various controls such as the control with respect to a folder, which is displayed on the display 2A, according to a gesture detected through the touch screen 2B. The functions provided by the control program 9A can be used in combination with a function provided by the other program such as the mail application 9B.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the smartphone 1 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, the receiver 7, and the speaker 11. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control program 9A to thereby perform the control with respect to a folder, which is displayed on the display 2A, according to a gesture detected through the touch screen 2B.

The camera 12 is an in-camera for photographing an object facing the front face 1A. The camera 13 is an out-camera for photographing an object facing the back face 1B.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the smartphone 1. The direction sensor 16 detects a direction of geomagnetism. The gyroscope 17 detects an angle and an angular velocity of the smartphone 1. The detection results of the acceleration sensor 15, the direction sensor 16, and the gyroscope 17 are used in combination with each other in order to detect a position of the smartphone 1 and a change of its attitude.

Part or all of the programs and the data stored in the storage 9 in FIG. 5 may be downloaded from any other device through communication by the communication unit 6. Part or all of the programs and the data stored in the storage 9 in FIG. 5 may be stored in the non-transitory storage medium that can be read by the reader included in the storage 9. Part or all of the programs and the data stored in the storage 9 in FIG. 5 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the smartphone 1 illustrated in FIG. 5 is only an example, and therefore it can be modified as required within a scope that does not depart from the gist of the present invention. For example, the number and the type of the button 3 are not limited to the example of FIG. 5. The smartphone 1 may be provided with buttons of a numeric keypad layout or a QWERTY layout and so on as buttons for operation of the screen instead of the buttons 3A to 3C. The smartphone 1 may be provided with only one button to operate the screen, or with no button. In the example of FIG. 5, the smartphone 1 is provided with two cameras; however, the smartphone 1 may be provided with only one camera or with no camera. In the example of FIG. 5, the smartphone 1 is provided with three types of sensors in order to detect its position and attitude; however, the smartphone 1 does not have to be provided with some of the sensors. Alternatively, the smartphone 1 may be provided with any other type of sensor for detecting at least one of the position and the attitude.

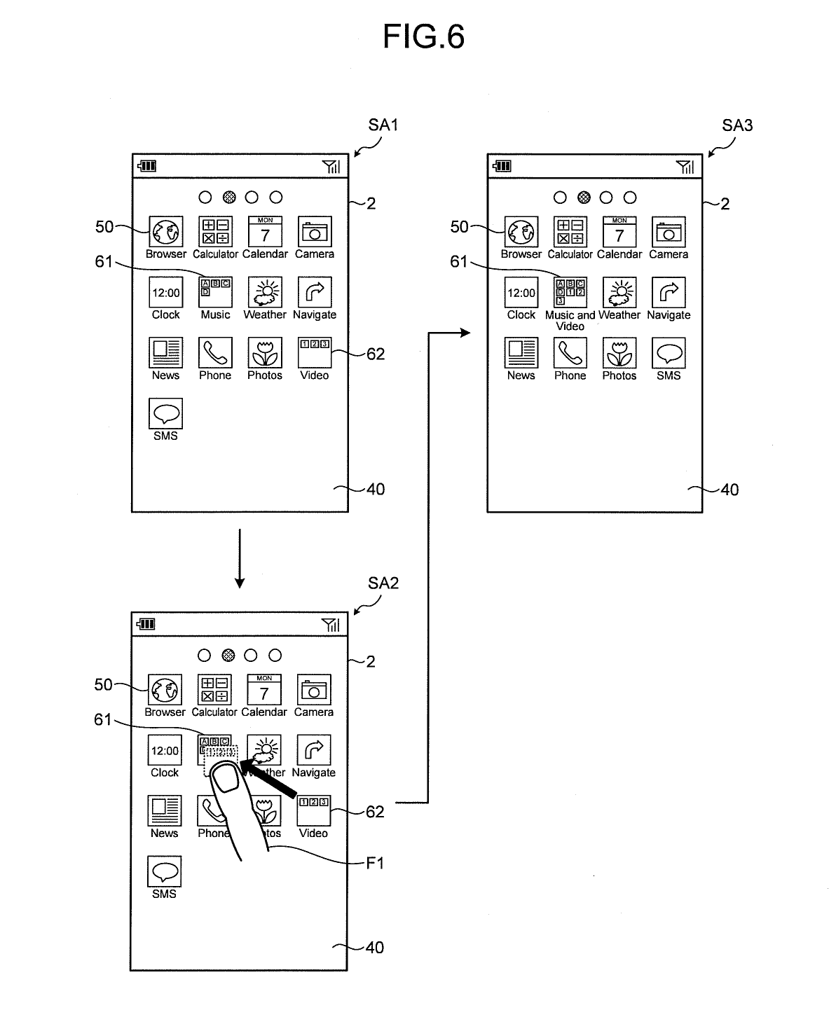

An example of operation of the smartphone 1 based on the function provided by the control program 9A will be explained with reference to FIG. 6. FIG. 6 is a diagram illustrating an example of combining of folders. At Step SA1 as illustrated in FIG. 6, the smartphone 1 has not only the icons 50 but also the folder 61 and the folder 62 arranged on the home screen 40.

The folder 61 and the folder 62 function as containers for storing icons 50. Thumbnails obtained by reducing the images of the stored icons 50 are arranged on the folder 61 and the folder 62. Names can be given to the folder 61 and the folder 62. For example, names are given to the folder 61 and the folder 62 so as to easily remind of the stored icons 50. In the example illustrated in FIG. 6, a name “music” is given to the folder 61, and a name “video” is given to the folder 62. In the example illustrated in FIG. 6, the folder 61 and the folder 62 are in rectangular shapes, but the shapes of the folder 61 and the folder 62 are not limited thereto.

The smartphone 1 combines the folder 61 and the folder 62 when predetermined operation on at least one of the folder 61 and the folder 62 is detected. In this case, “combine” means that icons 50 stored in each of multiple folders are moved to one folder. An example of predetermined operation on at least one of the folder 61 and the folder 62 includes gesture for dragging one of the folder 61 and the folder 62 to have it overlaid on the other of the folder 61 and the folder 62.

At Step SA2 illustrated in FIG. 6, a user uses a finger F1 to drag the folder 62. When the smartphone 1 detects dragging of the folder 62 with the touch screen 2B, the smartphone 1 moves the folder 62 in accordance with the movement of the finger F1 dragged. Then, when the smartphone 1 detects release of the finger F1 with the touch screen 2B while the moving folder 62 is overlaid on the folder 61, the smartphone 1 combines the folder 61 and the folder 62. In this case, the smartphone 1 moves all the icons 50 stored in the dragged folder 62 to the overlaid folder 61.

When the smartphone 1 detects dragging of the folder 62 with the touch screen 2B, the smartphone 1 may not move the folder 62 itself, but may move a dummy having a similar appearance to the folder 62 in accordance with the movement of the finger F1. In this case, when the smartphone 1 detects release of the finger F1 with the touch screen 2B while the dummy is overlaid on the folder 61, the smartphone 1 combines the folder 61 and the folder 62. That is, when the dummy having a similar appearance to the dragged folder is moved instead of the dragged folder, the position where the folder is dragged is determined on the basis of the position where the dummy is displayed. In the explanation below, explanation about the dummy is omitted, but in cases where the folder is dragged, the folder 62 may not follow the finger, and the dummy may follow the finger.

As illustrated in FIG. 6, the smartphone 1 allows the user to combine folders with simple operation. When the folders are combined, the user does not have to perform operation for moving icons one by one, and therefore, this improves the operability of folders.

Further, when the smartphone 1 combines folders, the name of the combined folder is set on the basis of the names of the folders before combining. At Step SA3 illustrated in FIG. 6, the smartphone 1 changes the name of the folder 61 to “music and video”, which is made by adding “video”, i.e., the name of the folder 62, to “music”, i.e., the original name of the folder 61. As described above, adding the name of the folder 62 to the name of the folder 61 allows the user to easily remind of the contents of the combined folder 61. Adding of the names may be done so that a character other than “and” or a line feed may be interposed, e.g., “music video”, “music, video”, and “music : video”, or nothing may be interposed, e.g., “music video”.

Further, the smartphone 1 deletes the folder 62 which is vacant. At Step SA3, the folder 62 is deleted, and the icon 50 is arranged at the position where the folder 62 had been arranged on the home screen 40. Since the number of icons 50 stored in the folder 61 increases, the number of thumbnails arranged on the folder 61 increases.

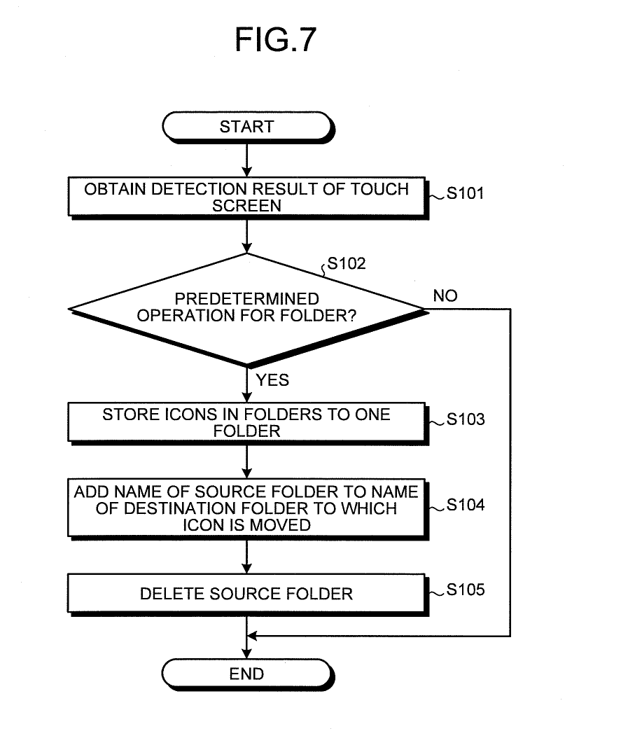

An example of processing procedure of control based on the functions provided by the control program 9A will be explained with reference to FIG. 7. FIG. 7 illustrates processing procedure of combining processing of folders. The processing procedure illustrated in FIG. 7 is achieved when the controller 10 executes the control program 9A. The processing procedure illustrated in FIG. 7 is executed on every detection of operation performed for the folder 60 arranged on the home screen 40. In parallel with the processing procedure illustrated in FIG. 7, the controller 10 may execute another processing procedure for the control of the home screen 40.

At Step S101, the controller 10 obtains a detection result of the touch screen 2B. Then, at Step S102, the controller 10 determines whether predetermined operation is performed for one or multiple folders. When the predetermined operation is not performed for one or multiple folders (Step S102, No), the controller 10 does not perform any processing concerning the combining processing.

When the predetermined operation is performed for one or multiple folders (Step S102, Yes), then at Step S103, the controller 10 moves all the icons 50 stored in the source folder to the destination folder. When the predetermined operation is operation for dragging the first folder so as to have it overlaid on the second folder, the source folder is the first folder, and the destination folder is the second folder.

Subsequently, at Step S104, the controller 10 adds the name of the source folder to the name of the destination folder of the icon 50. Then, at Step S105, the controller 10 deletes the source folder.

The above embodiment may be modified as follows.

For example, each program illustrated in FIG. 5 may be divided into multiple modules. Alternatively, each program illustrated in FIG. 5 may be combined with another program.

In the above embodiment, an example is described in which a folder is dragged to have it overlaid on another folder in order to combine the folders. However, operation for combining the folders is not limited thereto. For example, the operation for combining the folders may be an operation for dragging multiple folders and bringing them closer to each other.

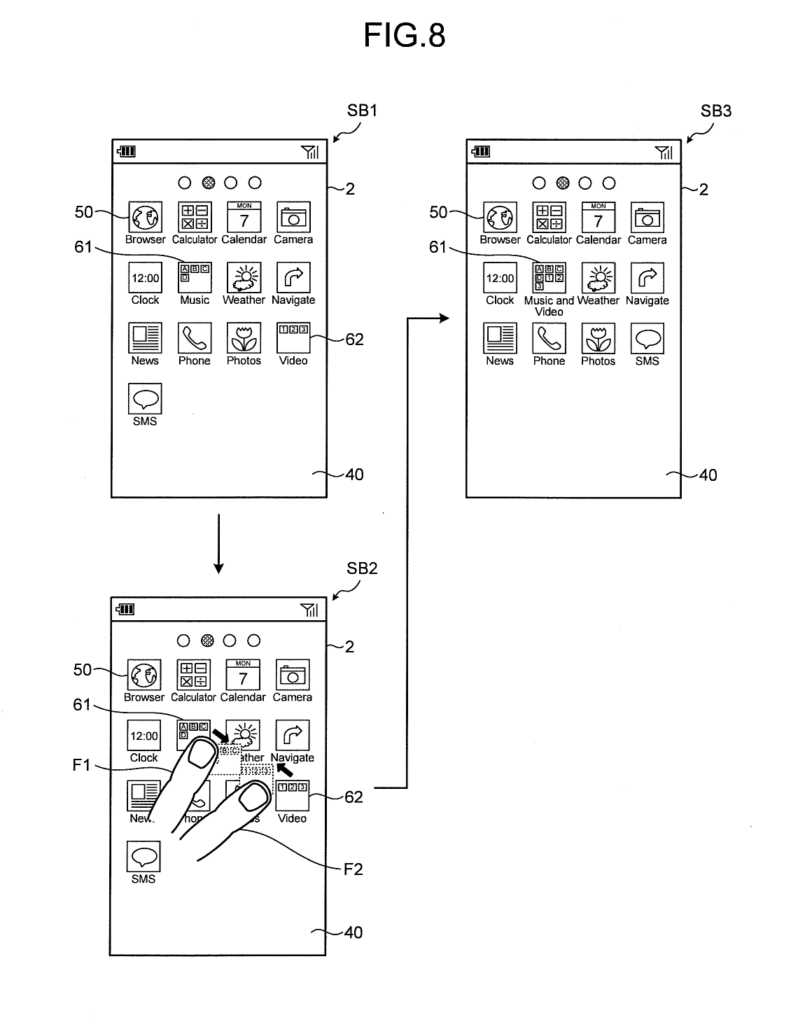

FIG. 8 is a diagram illustrating an example of operation for dragging multiple folders and bringing them closer to each other. Like Step SA1 illustrated in FIG. 6, the smartphone 1 arranges not only the icons 50 but also the folder 61 and the folder 62 on the home screen 40 at Step SB1 illustrated in FIG. 8.

At Step SB2, the user uses the fingers F1 and F2 to drag the folder 61 and the folder 62 and bring them closer to each other. When the smartphone 1 detects dragging of the folder 61 and the folder 62 with the touch screen 2B, the smartphone 1 moves the folder 61 and the folder 62 in accordance with the movement of the dragged fingers F1 and F2. Then, when the distance between the folder 61 and the folder 62 is less than a threshold value, and the smartphone 1 detects release of at least one of the fingers F1 and F2 with the touch screen 2B, the smartphone 1 combines the folder 61 and the folder 62. Alternatively, when the folder 61 and the folder 62 are overlaid on each other, and the smartphone 1 detects release of at least one of the fingers F1 and F2 with the touch screen 2B, the smartphone may combine the folder 61 and the folder 62.

In this case, the smartphone 1 may adopt, as the destination folder, the folder 61 of which arrangement order on the home screen 40 is former. Alternatively, the smartphone 1 may adopt, as the destination folder, the folder 62 of which arrangement order on the home screen 40 is later. Alternatively, the smartphone 1 may add a new folder on the home screen 40 and adopt the new folder as the destination folder, and after the stored icons 50 are moved, the folder 61 and the folder 62 may be deleted.

At Step SB3, the icons 50 stored in the folder 62 are moved to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

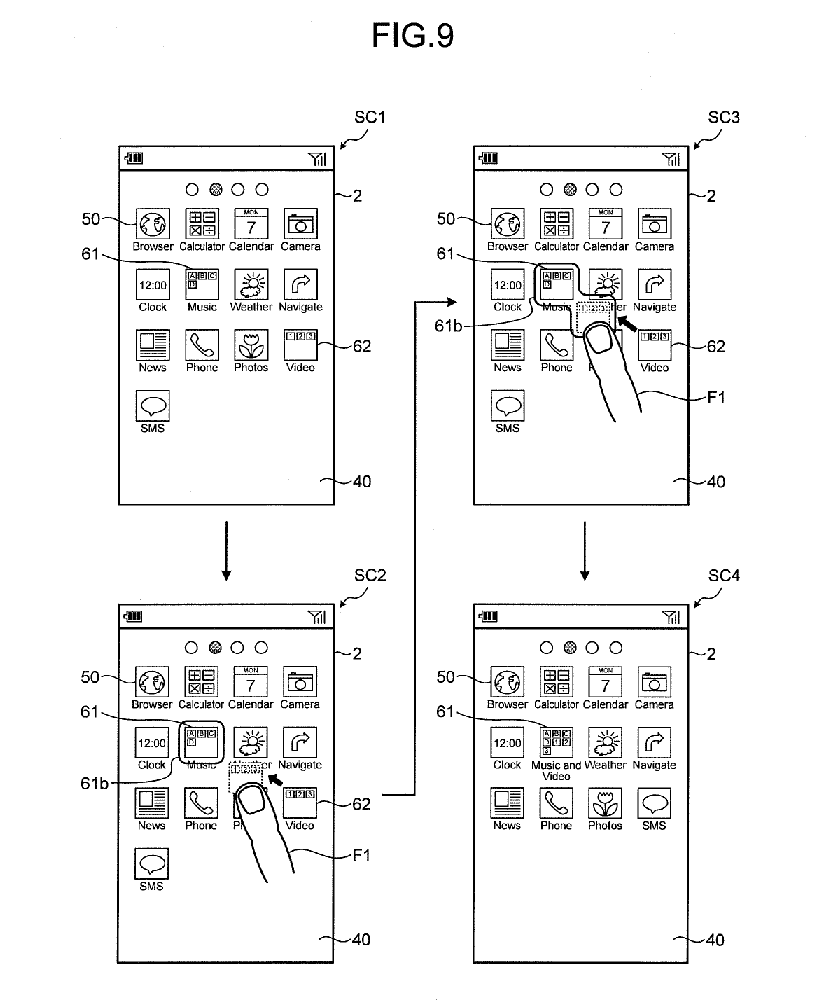

The operation for combining the folders may be operation for dragging one folder and bringing the folder closer to another folder. FIG. 9 is a diagram illustrating an example of operation for dragging one folder and bringing the folder closer to another folder. Like Step SA1 illustrated in FIG. 6, the smartphone 1 arranges not only the icons 50 but also the folder 61 and the folder 62 on the home screen 40 at Step SC1 illustrated in FIG. 9.

At Step SC2, the user uses the finger F1 to drag the folder 62 and bring the folder 62 closer to the folder 61. When the smartphone 1 detects dragging of the folder 62 with the touch screen 2B, the smartphone 1 moves the folder 62 in accordance with the movement of the dragged finger F1. Then, when the distance between the folder 61 and the folder 62 becomes less than a first threshold value, the smartphone 1 draws a frame 61b around the folder 61.

Further, when the folder 62 comes closer to the folder 61, and the distance between the folders becomes less than a second threshold value (second threshold value<first threshold value), the smartphone 1 updates the frame 61b so as to enclose not only the folder 61 but also the folder 62 as illustrated at Step SC3. When release of the finger F1 is detected with the touch screen 2B while the frame 61b encloses the folder 61 and the folder 62 as described above, the smartphone 1 combines the folder 61 and the folder 62. In this case, the smartphone 1 treats the dragged folder 62 as the source folder.

At Step SC4, the icons 50 stored in the folder 62 are moved to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

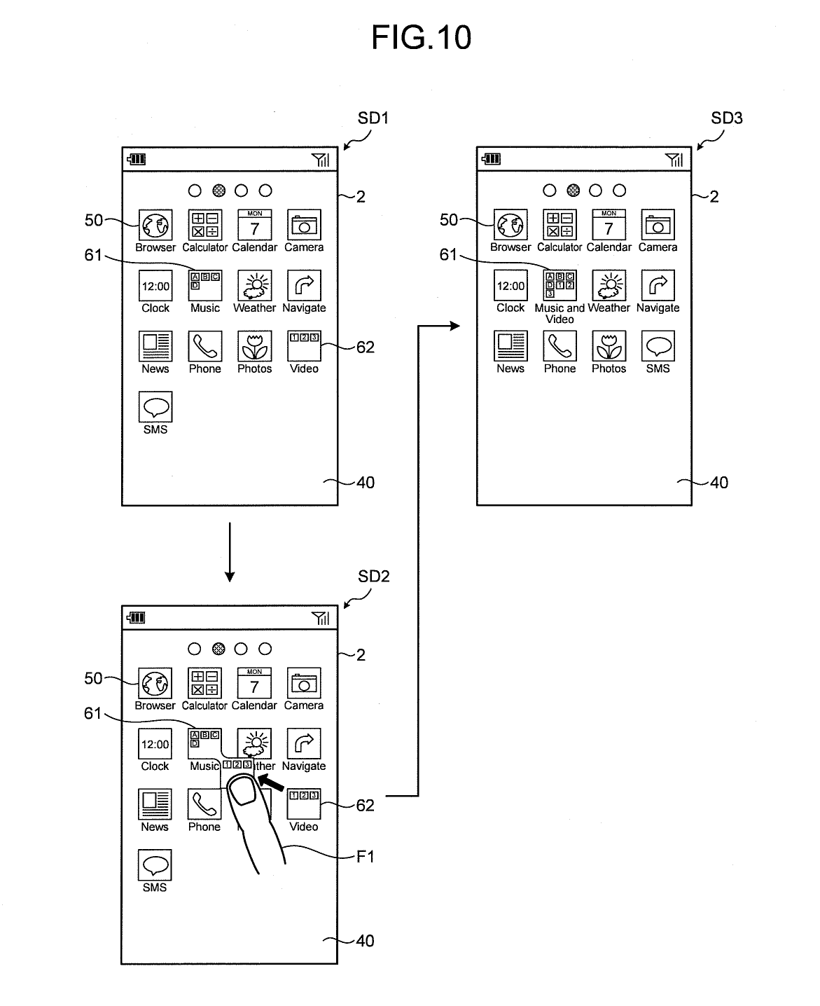

FIG. 10 is a diagram illustrating another example of operation for dragging a folder and bringing the folder closer to another folder. Like Step SA1 illustrated in FIG. 6, the smartphone 1 arranges not only the icons 50 but also the folder 61 and the folder 62 on the home screen 40 at Step SD1 illustrated in FIG. 10.

At Step SD2, the user uses the finger F1 to drag the folder 62 and bring the folder 62 closer to the folder 61. When the smartphone 1 detects dragging of the folder 62 with the touch screen 2B, the smartphone 1 moves the folder 62 in accordance with the movement of the dragged finger F1. Then, when the distance between the folder 61 and the folder 62 becomes less than a threshold value, the smartphone 1 displays the folder 61 and the folder 62 in such a manner that they are connected with each other.

When release of the finger F1 is detected with the touch screen 2B while the folder 61 and the folder 62 are displayed in such a manner that they are connected with each other, the smartphone 1 combines the folder 61 and the folder 62. In this case, the smartphone 1 treats the dragged folder 62 as the source folder.

At Step SD3, the icons 50 stored in the folder 62 move to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

As illustrated in FIGS. 9 and 10, when the operation for combining folders is operation for dragging a folder and bringing the folder closer to another folder, the user may be notified of that the distance between the folders becomes less than the threshold value at which the combining process is executed. This notification allows the user to easily find the timing for terminating the dragging. The notification is not limited to a visual notification as illustrated in FIGS. 9 and 10, and the notification may be given using sound, vibration, and the like.

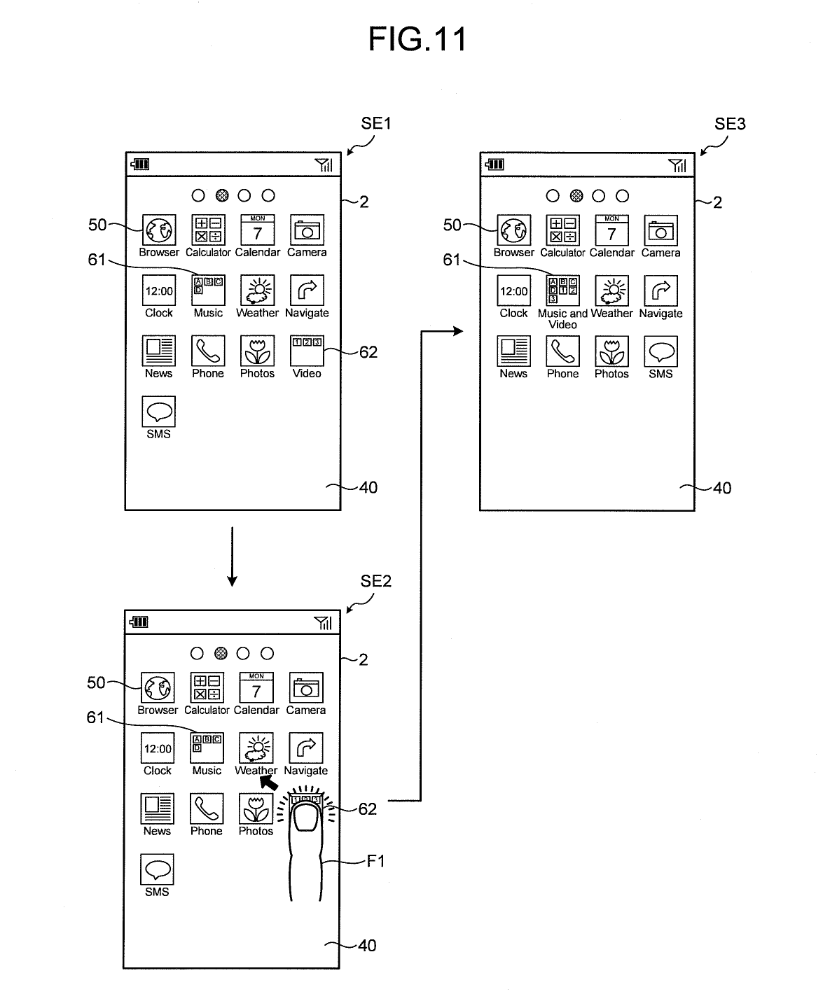

The operation for combining folders may be operation for flicking a folder in a direction of another folder. FIG. 11 is a diagram illustrating an example of operation for flicking a folder in a direction of another folder. Like Step SA1 illustrated in FIG. 6, the smartphone 1 arranges not only the icons 50 but also the folder 61 and the folder 62 on the home screen 40 at Step SE1 illustrated in FIG. 11.

At Step SE2, the user uses the finger F1 to perform flick operation within a display region of the folder 62 in a direction of the folder 61. When the smartphone 1 detects the flick operation within the display region of the folder 62 in the direction of the folder 61 with the touch screen 2B, the smartphone 1 combines the folder 61 and the folder 62. In this case, the smartphone 1 treats the folder 62, on which the flick operation is performed, as the source folder.

At Step SE3, the icons 50 stored in the folder 62 are moved to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

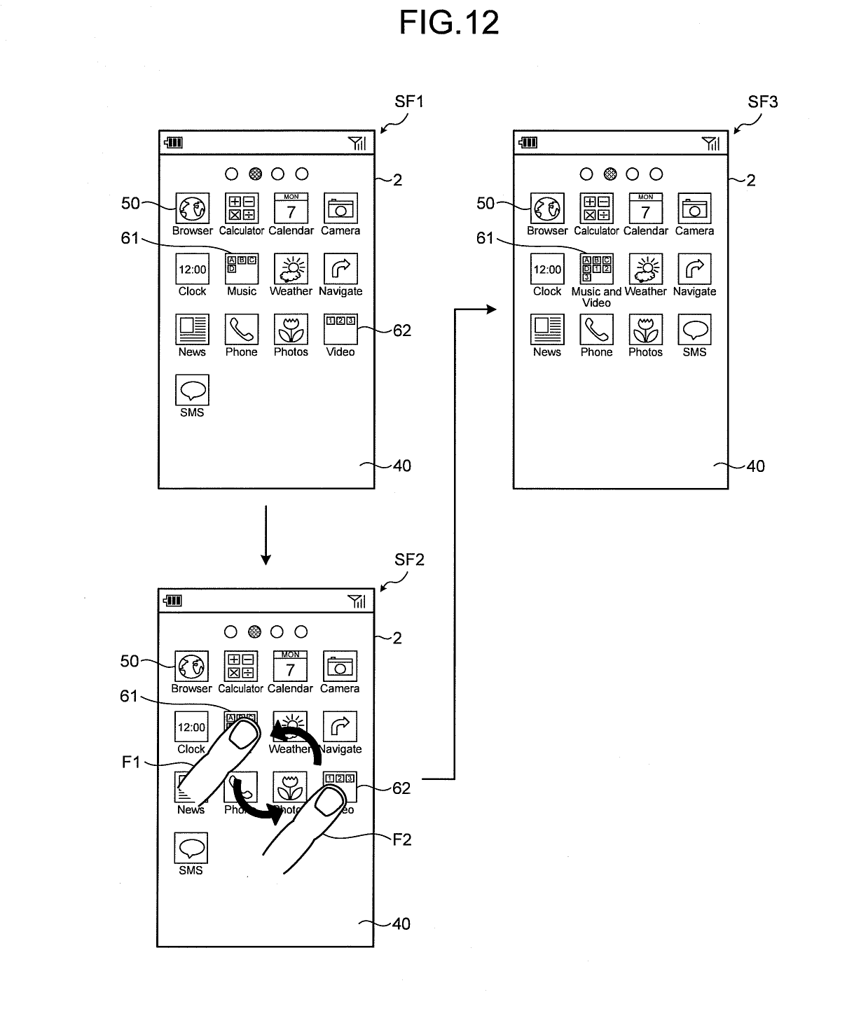

The operation for combining the folders may be multi-touch gesture other than the operation for dragging multiple folders and bringing them closer to each other as illustrated in FIG. 8. The “multi-touch gesture” is gesture made by bringing multiple fingers into contact with the touch screen 2B. FIG. 12 is a diagram illustrating an example of a multi-touch gesture. Like Step SA1 illustrated in FIG. 6, the smartphone 1 has not only the icons 50 but also the folder 61 and the folder 62 arranged on the home screen 40 at Step SF1 illustrated in FIG. 12.

At Step SF2, the user uses the fingers F1 and F2 to make multi-touch gesture for the folder 61 and the folder 62. More specifically, the user brings the finger F1 into contact with the touch screen 2B in the display region of the folder 61, and brings the finger F2 into contact with the touch screen 2B in the display region of the folder 62. Then, the user rotates the fingers F1 and F2 in a counterclockwise direction. When it is detected, with the touch screen 2B, that the fingers placed on the folder 61 and the folder 62 are moved on the touch screen 2B to rotate thereon as described above, the smartphone 1 combines the folder 61 and the folder 62.

In this case, the smartphone 1 may adopt, as the destination folder, the folder 61 of which arrangement order on the home screen 40 is former. Alternatively, the smartphone 1 may adopt, as the destination folder, the folder 62 of which arrangement order on the home screen 40 is later. Alternatively, the smartphone 1 may add a new folder on the home screen 40 and adopt the new folder as the destination folder, and after the stored icons 50 are moved, the folder 61 and the folder 62 may be deleted.

At Step SF3, the icons 50 stored in the folder 62 are moved to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

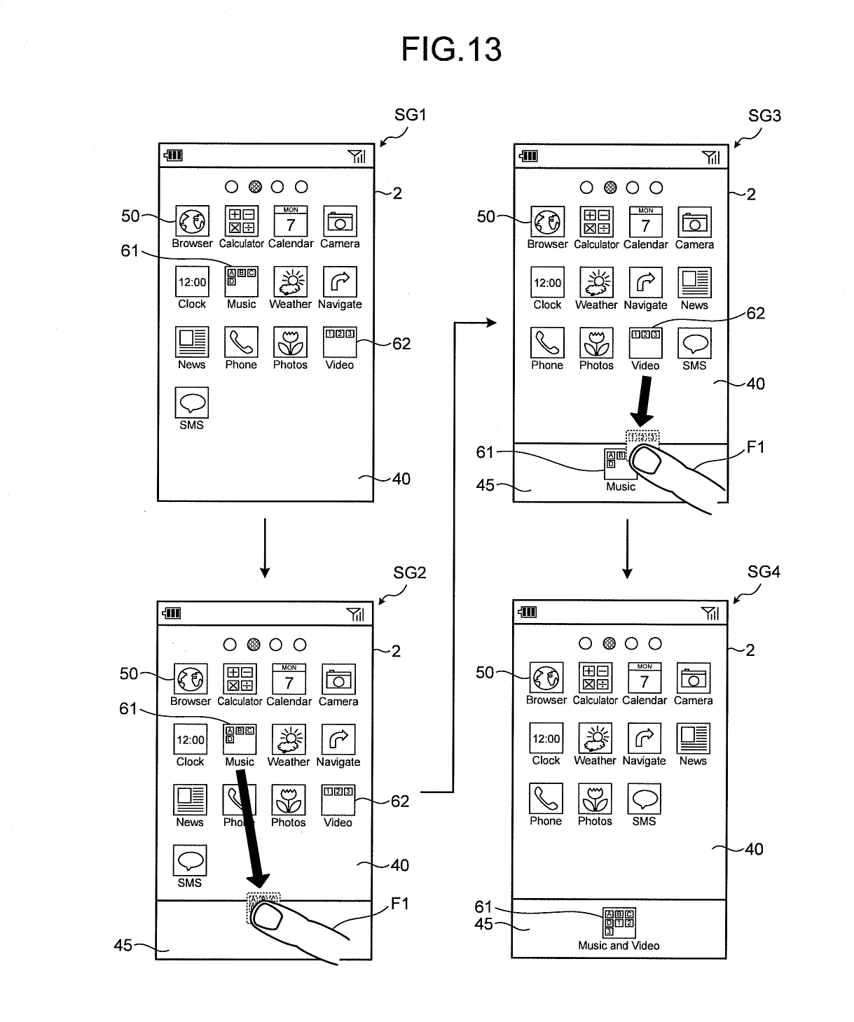

FIG. 13 is a diagram illustrating another example of operation for combining folders. Like Step SA1 illustrated in FIG. 6, the smartphone 1 has not only the icons 50 but also the folder 61 and the folder 62 arranged on the home screen 40 at Step SG1 illustrated in FIG. 13.

At Step SG2, the user uses the finger F1 to drag the folder 61, and brings the folder 61 closer to the lower end of the display 2A. When the smartphone 1 detects dragging of the folder 61 with the touch screen 2B, the smartphone 1 moves the folder 61 in accordance with the movement of the dragged finger F1. Then, when the distance between the folder 61 and the lower end of the display 2A becomes less than a threshold value, the smartphone 1 arranges a region 45 at the lower end of the display 2A.

The region 45 has a size capable of accommodating at least the folder 61. When the home screen 40 is displayed, the region 45 may be provided always at the lower end of the display 2A or in other portions. When another home screen 40 is displayed, the region 45 may be still displayed as it is.

When at least a portion of the folder 61 is in the region 45, and release of the finger F1 is detected with the touch screen 2B, the smartphone 1 moves the folder 61 to the region 45 as illustrated in Step SG3.

Thereafter, as illustrated in Step SG3, the user drags the folder 62 and has the folder 62 overlaid on the folder 61. When the smartphone 1 detects release of the finger F1 with the touch screen 2B while the moving folder 62 is overlaid on the folder 61, the smartphone 1 combines the folder 61 and the folder 62. In this case, the smartphone 1 adopts the dragged folder 62 as the source folder.

At Step SG4, the icons 50 stored in the folder 62 are moved to the folder 61, and the number of thumbnails arranged on the folder 61 increases. The name of the folder 61 is added with the name of the folder 62, so that the name of the folder 61 is “music and video”. The folder 62 is deleted, and the icon 50 is arranged at the position where the folder 62 had been arranged on the home screen 40.

When the folder 61 is dragged to the outside of the region 45 in the state of Step SG4, the smartphone 1 moves the folder 61 to the position corresponding to the end point of dragging. When another folder is further dragged onto the folder 61 in the state of Step SG4, the smartphone 1 combines the another folder and the folder 61.

In the embodiment, a name of the folder after the combining is set by connecting names of the folders before the combining; however, the naming of the folder after the combining is not limited thereto. For example, name of the folder after the combining may be set based on attribute(s) of application(s) corresponding to icon(s) included in the folder the combining, such as type(s) thereof, usage(s) thereof, etc.

In the embodiment, the smartphone has been explained as an example of the device provided with the touch screen; however, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic devices include, but are not limited to, desktop personal computers, automatic teller machines (ATM), and television receivers.

“Upon combining the first folder and the second folder” or “When combining the first folder and the second folder” is a concept that includes not only a timing when the controller detects that the distance between the first folder and the second folder is less than a threshold value, but also an arbitrary timing in a period between the detection of a predetermined gesture on at least one of the folders and the detection of release of at least one of the fingers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device comprising:
a touch screen display for displaying a first folder storing a first icon and a second folder storing a second icon; and
a controller for combining the first folder and the second folder in accordance with a predetermined gesture made on the touch screen display.

2. The apparatus according to claim 1, wherein
upon combining the first folder and the second folder, the controller is configured to
store the first icon and the second icon to one of the first folder and the second folder, and
delete the other thereof.

3. The apparatus according to claim 1, wherein
upon combining the first folder and the second folder, the controller is configured to
generate a third folder,
store the first icon and the second icon to the third folder, and
delete the first folder and the second folder.

4. The apparatus according to claim 1, wherein
the controller is configured to determine a name of a folder after the combining, on the basis of a name of the first folder and a name of the second folder.

5. The apparatus according to claim 1, wherein
the predetermined gesture is a gesture made for at least one of the first folder and the second folder.

6. A method for controlling a device having a touch screen display, the method comprising:
displaying a first folder storing a first icon and a second folder storing a second icon on the touch screen display;
detecting, with the touch screen display, a predetermined gesture; and
combining the first folder and the second folder in accordance with the predetermined gesture.

7. A non-transitory storage medium that stores a program for causing, when executed by a device having a touch screen display, the device to execute:
displaying a first folder storing a first icon and a second folder storing a second icon on the touch screen display;
detecting, with the touch screen display, a predetermined gesture; and
combining the first folder and the second folder in accordance with the predetermined gesture.
